(19) United States
(12) Patent Application Publication
(10) Pub. No.: US 2024/0427096 A1
(43) Pub. Date: Dec. 26, 2024

(54) FIBER OPTIC CABLE COUPLING ASSEMBLY

(71) Applicant: Plethron, Inc., Palo Alto, CA (US)

(72) Inventor: Eric Minami, Palo Alto, CA (US)

(21) Appl. No.: 18/628,628

(22) Filed: Apr. 5, 2024

Related U.S. Application Data
(60) Provisional application No. 63/509,090, filed on Jun. 20, 2023.

(51) Int. Cl. G02B 6/42; G02B 6/43

(52) U.S. Cl. CPC G02B 6/4295; G02B 6/4228; G02B 6/43

(57) ABSTRACT

Numerous examples are disclosed of a fiber optic cable coupling assembly and components thereof. In one example, a fiber optic cable coupling assembly comprises a coupling board containing a plurality of lasers and a plurality of photodiodes; and a mechanical-optical interface comprising a first plurality of ferrules and a plurality of lasers, where each laser in the plurality of lasers is aligned with a ferrule in the first plurality of ferrules; and a second plurality of ferrules and a plurality of photodiodes, wherein each photodiode in the plurality of photodiodes is aligned with a ferrule in the second plurality of ferrules.

### PRIORITY CLAIM

This application claims priority to U.S. Provisional Application No. 63/509,090, filed on Jun. 20, 2023, and titled “Low-Cost Silicon Photodiode based Active Optical Cable,” which is incorporated by reference herein.

### FIELD OF THE INVENTION

Numerous examples are disclosed of a fiber optic cable coupling assembly.

### BACKGROUND OF THE INVENTION

The data rate of high-speed communication in the modern data center is reaching an upper limit based on limitations of the physical layer medium and components. There are tradeoffs between bandwidth, physical reach, and cost. For example, Active Electrical Cables (AEC) based on high quality electrical coaxial cables can sustain an electrical bandwidth of 50 GHz with a reach of 5 meters, but increasing the bandwidth or reach further is unachievable. At frequencies above 50 GHz, signal attenuation becomes too high for transceiver circuits to recover the underlying signals. A further tradeoff involving propagation mode control and signal attenuation creates a further limitation on reach, such that it is not possible to have a reach greater than 3 meters economically. The simple solution of making parallel electrical coaxial cables is also limited by the physical size of parallel coaxial cabling, which are relatively bulky. In addition, parallel electrical cabling results in high electrical power consumption which scales with the number of parallel coaxial cables.

Fiber optic cable, with its small physical dimension and high bandwidth capacity, can attain a much longer reach than electrical cables. Active Optical Cable (AOC) is a cabling technology with a fixed length that has the same electrical input and output as AEC but uses fiber optics to send high bandwidth signals. Traditional implementations of high bandwidth AOC are expensive, due to high assembly cost of the optical engine that is used for transmitting (TX) and receiving (RX) signals, as well as availability of lasers and photodiodes that can used at bandwidths greater than 50 GHz. The overall cost of ownership is the major bottleneck to wide-spread replacement of AEC with AOC.

### SUMMARY OF THE INVENTION

There is a need for low-cost AOC that uses parallel optical fibers with silicon die integrated with high-speed avalanche photodiodes (APD), transimpedance amplifiers (TIA), and vertical cavity surface emitting laser (VCSEL) laser drivers in a low-cost fiber coupling package to serve data center connections, with a longer reach (e.g., 50 meters) and greater bandwidth (e.g., 800 Gbps) than is available with AEC.

Embodiments are disclosed herein of integrated silicon-based photodiodes or avalanche photodiodes with TIAs and VCSEL laser drivers to enable simple multi-fiber alignment.

APD is used for the receiving (RX) side of the cable. APD has superior bandwidth and sensitivity compared to a standard photodiode. As an integrated component on the same silicon substrate as TIA, a linear array or matrix arrangement of APD can be photo-lithographically defined to achieve high level of dimension accuracy for fiber array coupling alignment. Typically, integrated silicon APD has optical wavelength responsivity from 200 nm to 900 nm, with its peak responsivity between 600 nm to 700 nm. Although this is a shorter wavelength than that typically used for optical fiber data communication, fiber optic cable attenuation at 600 nm to 700 nm at distance up to 50 meters is less than 1 dB. Integrated APD allows orders of magnitude reduction in extrinsic resistance, inductance, and capacitance (RLC) parasitic from bond pad and bond wire between discrete photodiode and TIA die.

VCSEL is used for the transmitting (TX) side of the cable. A VCSEL array is arranged in either a linear or matrix format depending on the need of parallel fiber optic cables. Due to the sensitivity of APD, VCSEL modulation current can be kept low while achieving the required cable reach. This will result in lower energy/bit for the connection compared to other solutions.

The electrical outputs of the APD/TIA and the electrical input to the laser driver/VCSEL are coupled to a high-speed transceiver chip to form one end of a typical AOC cable.

Several mechanisms and methods are described herein to align and assemble either a linear or matrix array of fibers using precision optical fiber ferrule fixtures and lithographically defined alignment boxes. Ferrule fixtures and coupling fixtures allow fiber alignment to be done in a single batch process. This single batch process is a low-cost, single-step passive alignment process unlike the process used in standard optical engine construction. To increase the cable data rate, the number of fibers can be increased without a proportional increase in manufacturing cost. Ferrule fixtures and coupling fixtures are manufactured in batch mode. High-speed signals between the coupling assembly and transceiver chip can be transmitted through one or more impedance controlled flexible printed circuit (FPC) or through PCB vias. This component integration approach enables several possibilities for reducing the cost of AOC manufacturing and AOC deployment.

Also described is a system and method for automated optimization of signals in each optical fiber through closed-loop feedback control to reduce operating power, increase manufacturing yield, and reduce maintenance cost.

### BRIEF DESCRIPTION OF THE DRAWINGS

FIG. 1 depicts a fiber optic cable coupling assembly.

FIGS. 2A, 2B, and 2C depict a fiber optic cable coupling assembly.

FIG. 3 depicts a fiber optic cable coupling assembly.

FIGS. 4A and 4B show additional details of the vertical coupling fixture of the fiber optic cable coupling assembly of FIG. 3.

FIG. 5 depicts a vertical coupling fixture that can be used as an alternative to the vertical coupling fixture of FIGS. 4A and 4B.

FIG. 6 depicts a side-view of a vertical coupling fixture that can be used as an alternative to the vertical coupling fixtures of FIGS. 4A, 4B, and 5.

FIG. 7 depicts a top view of a coupling board,

FIG. 8 depicts alignment boxes.

FIG. 9 depicts a cross-section of a ferrule fixture aligned with alignment boxes.

FIG. 10 depicts alignment boxes.

FIG. 11 depicts a cross-section of a ferrule fixture aligned with alignment boxes.

FIG. 12 depicts a top view of a coupling board.

FIG. 13 depicts a cross-section of a ferrule fixture aligned with alignment boxes.

FIG. 14 depicts a top view of a coupling board.

FIG. 15 depicts electrical aspects of a fiber optic cable coupling assembly.

FIG. 16 depicts closed-loop control and optimization of performance metrics.

FIG. 17 depicts controls that can be set by an optimization circuit.

FIGS. 18A, 18B, and 18C depict an embodiment with multiple APDs per fiber.

FIG. 19 depicts an embodiment with multiple APDs per fiber.

FIGS. 20A and 20B depict embodiments with an alignment box containing a laser and an APD.

FIG. 21 depicts a system comprising two devices communicating using fiber optic cable coupling assemblies.

### DETAILED DESCRIPTION OF THE INVENTION

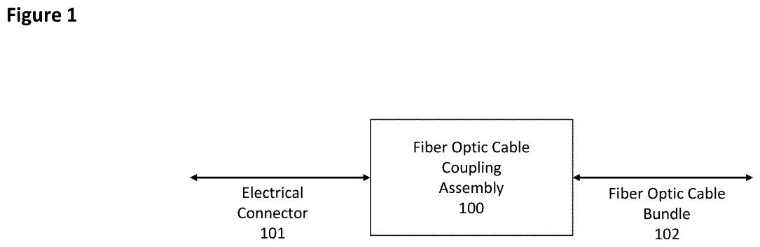

FIG. 1 depicts fiber optic cable coupling assembly 100. Fiber optic cable coupling assembly 100 connects to electrical connector 101 and fiber optic cable bundle 102. Fiber optic cable coupling assembly 100 receives optical signals from fiber optic cable bundle 102, translates the optical signals into electrical signals, and transmits the electrical signals over electrical connector 101. Similarly, fiber optic cable coupling assembly 100 receives electrical signals from electrical connector 101, translates the electrical signals into optical signals, and transmits the optical signals over fiber optic cable bundle 102.

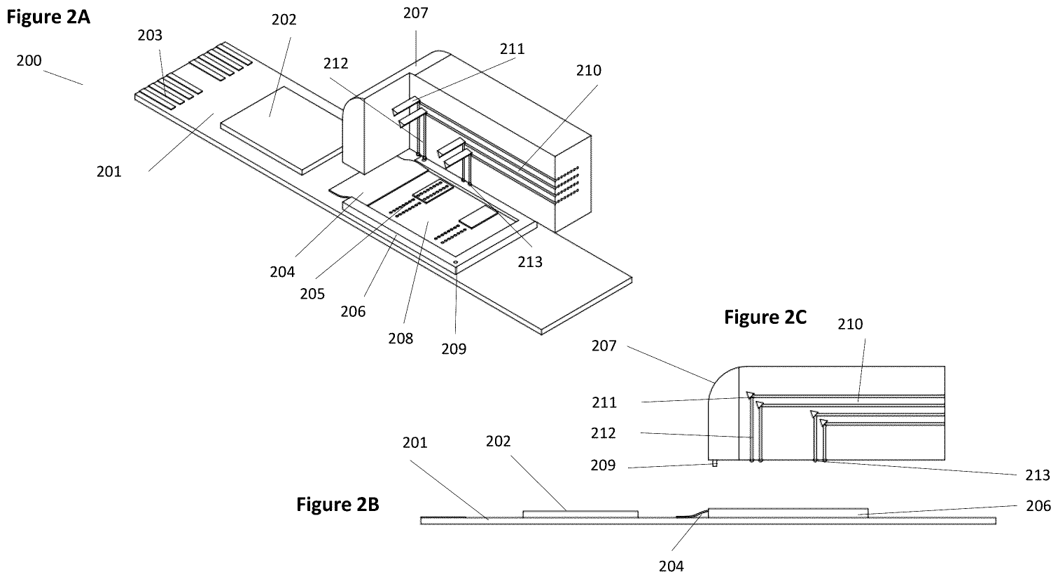

FIG. 2A depicts an isometric view of fiber optic cable coupling assembly 200, which is an embodiment of fiber optic cable coupling assembly 100 in FIG. 1. Fiber optic cable coupling assembly 200 comprises PCB 201, transceiver chip 202, gold fingers 203, FPC 204, alignment boxes 205, coupling fixture 206, mechanical-optical interface 207, coupling board 208, precision guide pin/hole 209, ferrules 210, optical device 211 (which can be a mirror or prism), and ferrules 212. Fiber optic cable coupling assembly 200 optionally is physically mounted at the end of an AOC cable containing fiber optic cable bundle 102 in FIG. 1.

PCB 201 holds transceiver chip 202 interfacing between electrical connector 101 (not shown) and the fiber optic cable coupling assembly 200. At one end of PCB 201, gold fingers 203 connect to electrical connector 101 (not shown) which in turn connects to an external system such as a server. Gold fingers 203 can form a QSFP (Quad Small Form Factor Pluggable) connector, SFP (Small Form-factor Pluggable) connector, or other type of connector.

Coupling fixture 206 forms a structure that establishes precision reference to mechanical-optical interface (MOI) 207, which here is an optical fiber ferrule fixture, that guides multiple optical fibers from a fiber cable bundle.

Coupling fixture 206 also forms protection around silicon die or dies containing APDs, TIAs, and laser drivers. VCSELs and APDs are arranged in an array configuration in alignment boxes 205. Coupling fixture 206 can be made of ceramic, metal, or plastic and is glued on to coupling board 208. Coupling board 208 can be laminated PCB. Alternatively, coupling board 208 can be ceramic PCB for high thermal stability. Coupling fixture 206 has at least one precision guide pin/hole 209 to allow mechanical-optical interface 207 to have repeatable alignment.

Fiber ferrules 210 run horizontally inside mechanical-optical interface 207. Each fiber in the AOC fiber bundle is assigned its own ferrule in mechanical-optical interface 207. For each fiber, a received optical signal is reflected by optical device 211 into mechanical-optical interface vertical ferrules 212. In the example shown, fiber ferrules 210 and vertical ferrules 212 are connected at approximately a 90 degree angle, but other angles can be used. To receive an optical signal from an optical fiber, lens 213 built into mechanical-optical interface 207 focuses the optical signal onto APDs. To transmit a signal to the optical fiber, lens 213 focuses VCSEL laser output into mechanical-optical interface vertical ferrule 212, which is reflected by optical device 211 into the optical fiber.

High-speed signals between coupling board 208 and PCB 201 can be connected through FPC 204 or through PCB vias. FPC can be made of polyimide or Teflon to have good high frequency characteristics.

FIG. 2B depicts a side view of certain components of fiber optic cable coupling assembly 200 including PCB 201, transceiver chip 202, FPC 204, and coupling fixture 206.

FIG. 2C depicts a side view of certain components of fiber optic cable coupling assembly 200 including mechanical-optical interface 207, precision guide pin/hole 209, fiber ferrules 210, optical device 211, and mechanical-optical interface vertical ferrules 212.

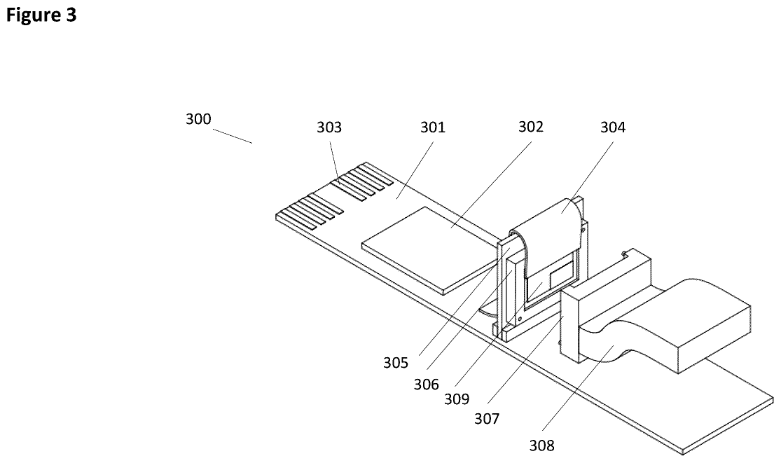

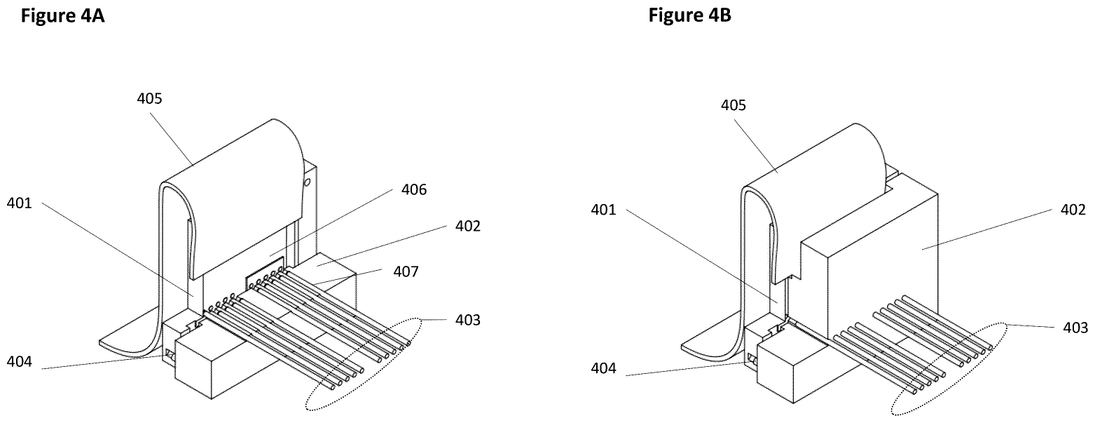

FIG. 3 depicts an isometric view of fiber optic cable coupling assembly 300, which is another embodiment of fiber optic cable coupling assembly 100. Fiber optic cable coupling assembly 300 comprises PCB 301, transceiver chip 302, gold fingers 303, FPC 304, section 305, coupling fixture 306, mechanical-optical interface 307, fiber ferrule fixture 308, and coupling board 309.

Coupling fixture 306 is arranged in a vertical position perpendicular to PCB 301 unlike coupling fixture 206 in fiber optic cable coupling assembly 200 in FIGS. 2A, 2B, and 2C. The advantage of this embodiment is that mechanical-optical interface 307 is simpler compared to mechanical-optical interface 207 in FIGS. 2A, 2B, and 2C because optical signals received from and sent to the fibers do not have to change direction and optical devices 211 are not needed.

Coupling fixture 306 forms a structure that establishes a precision mating with mechanical-optical interface 307 that guides multiple optical fibers from fiber optic cable bundle 102 in FIG. 1. Coupling fixture 306 also forms protection around silicon die or dies containing APDs, TIAs, and laser drivers. VCSELs and APDs are arranged in an array configuration in alignment boxes. Coupling fixture 306 can be made of ceramic, metal, or plastic. It is glued on to coupling board 309. Coupling board 309 can be laminated PCB. Alternatively, coupling board 309 can be ceramic PCB for high thermal stability. Coupling fixture 306 has at least one precision guide pin (or hole) to ensure alignment with mechanical-optical interface 307 to ensure alignment. Ferrules run horizontally inside fiber ferrule fixture 308. Each fiber in the fiber optic cable bundle 102 is assigned its own ferrule in mechanical-optical interface 307. The fibers directly couple to an APD or VCSEL array element, optionally through a lens.

FIGS. 4A and 4B show additional details of the coupling fixture 306 of fiber optic cable coupling assembly 300 from FIG. 3, with sections of coupling fixture 401 and ferrule fixture 402 cut out for greater clarity. FPC 405 connects the coupling board to the main PCB. Coupling fixture 401 and ferrule fixture 402 are perpendicular to fiber bundle 403 (which are fibers in fiber optic cable bundle 102). Coupling fixture 401 has at least one guide pin 404 (or hole) to ensure precision placement of fiber ferrule 407 to ensure alignment. Coupling fixture 401 also forms protection around silicon die or dies with APD, TIA, and laser driver 406. VCSEL and APDs are arranged in an array configuration. At least two pairs of guide pins and holes are preferred to limit the face-to-face rotation between coupling fixture 401 and fiber ferrule fixture 402. Fiber ferrules are built into ferrule fixture 402 in an array configuration with one or more rows. Each fiber in fiber bundle 403 is fixed to fiber ferrules at the exit hole of fiber ferrule.

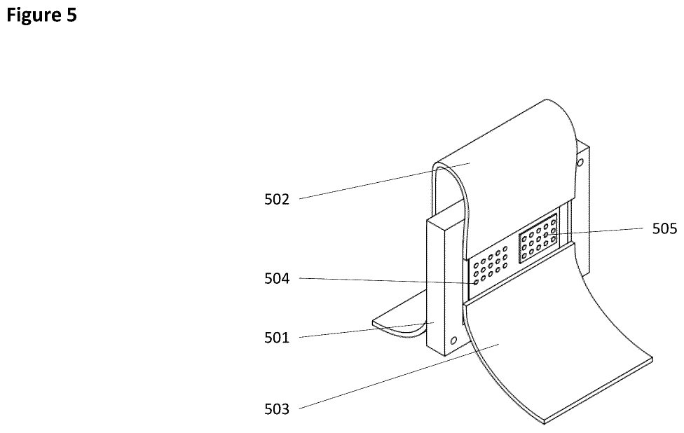

FIG. 5 shows vertical coupling fixture 501 that is a variation of coupling fixture 401 in FIGS. 4A and 4B. Vertical coupling fixture 501 couples with multiple FPCs 502 and 503. The number of FPCs can be increased by extending the vertical size of the coupling board to support additional rows of tape-automated bonding (TAB) to connect the FPCs. FIG. 5 also shows an embodiment with additional rows of APD 504 and VCSEL 505 to illustrate that the number of fibers can be increased to increase AOC data rate.

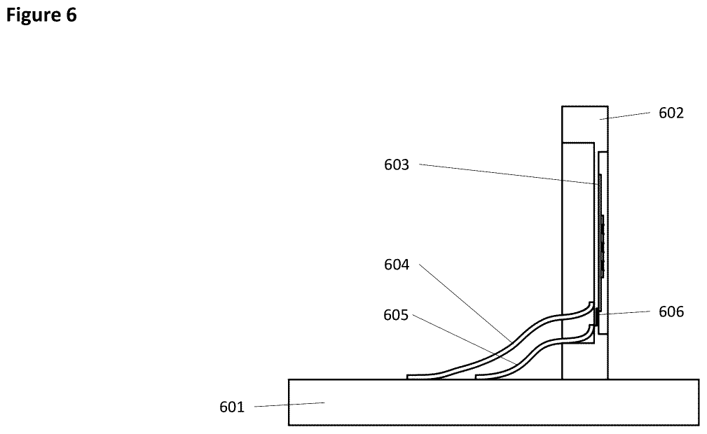

FIG. 6 shows a side-view of vertical coupling fixture 602 that can be used as an alternative to coupling fixture 401 in FIGS. 4A and 4B and vertical coupling fixture 501 in FIG. 5. Vertical coupling fixture 602 couples with multiple FPCs 604 and 605 connected at the backside of coupling board 603 through PCB vias 606. The number of FPCs can be increased by extending the vertical size of coupling board to support additional rows of PCB vias. FPCs 604 and 605 are connected to AOC PCB 601.

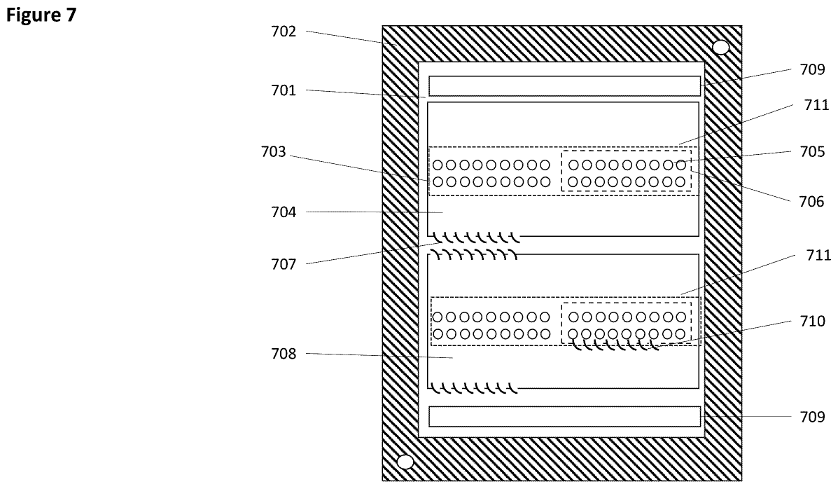

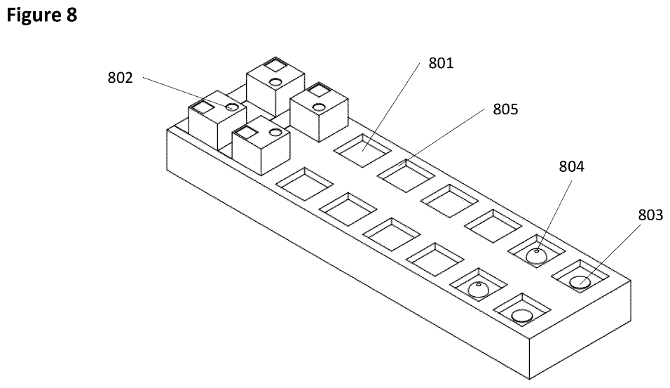

FIG. 7 shows a top view of coupling board 701 and its components, surrounded by coupling fixture 702. Coupling board 701 can be part of a horizontal embodiment (FIGS. 2A, 2B, 2C) or a vertical embodiment (FIGS. 3-5). APD array 703 is fabricated on silicon die 704. Silicon die 704 includes TIAs for amplification of signals from APD array 703 and laser drivers for providing currents to control VCSEL array 705. Coupling board 701 also contains both digital and analog control circuits for adjusting APD bias, TIA amplification, and laser drive currents.

VCSEL array 705 is constructed on a reserved region (VCSEL region 706) with alignment boxes 711 that are lithographically defined. Alignment boxes 711 also surround each APD in APD array 703. Each VCSEL is connected to silicon die 704 using wire bonds 710 and lithographically defined metal interconnects. Optionally, rows of VCSEL array 705 and rows of APD array 703 are aligned. The number of silicon die 704 can be increased depending on the total bandwidth requirement of the AOC product.

Silicon die 704 is attached to coupling board 701 using standard silicon chip packaging technologies. Silicon die 704 is electrically connected to coupling board 701 using wire bonds 707 or through silicon vias (TSV) or combination of both. Active electrical circuits for APD bias, TIA, laser driver, and other controls can exist anywhere on silicon die 704 outside of APD array.

In the example of FIG. 7, two silicon dice 704 and 708 are mounted on coupling board 701. This embodiment also has TAB regions 709 for attaching FPCs. TAB regions 709 are not required if high-speed signals are connected to AOC PCB through PCB vias.

FIG. 8 shows alignment boxes 801 for VCSEL and fiber placement. Alignment boxes 801 are lithographically defined. Alignment boxes 801 are an example implementation of alignment boxes 711 in FIG. 7. Alignment boxes 801 are defined using organic material, for example, polyimide, SU-8, or benzo-cyclobutene (BCB), and processed directly on silicon wafer before dicing. Multiple lithographically defined layers can be employed to build up appropriate height of box wall 805 to facilitate VCSEL placement and alignment. Each VCSEL die 802 in the VCSEL array is placed in one of the alignment boxes 801, and each APD 803 is placed in one of the alignment boxes 801.

Alignment boxes 801 are also used to assist in precision placement of fiber on top of APD 803. Furthermore, optical lens 804 may be placed or micro-lens may be lithographically defined in the alignment boxes 801 on top of an APD 803 to increase the intensity of the optical signal received by the APD active area. APD 803 can be further optimized with lithographically defined anti-reflective coating and optical filters.

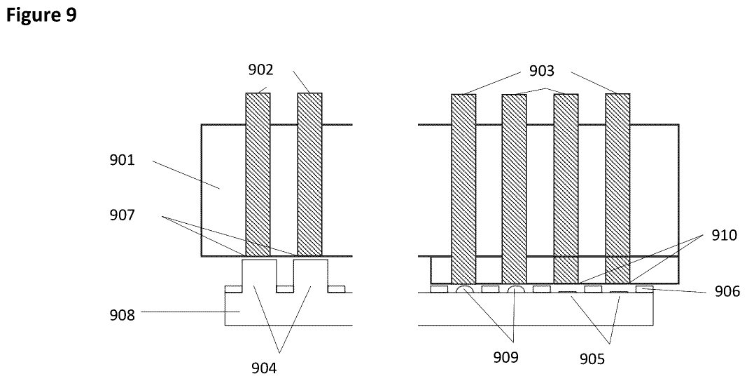

FIG. 9 shows a cross-section of ferrule fixture 901 that can be used within mechanical-optical interface 207 and mechanical-optical interface 307. Ferrule fixture 901 comprises transmit ferrules 902 and receive ferrules 903. Transmit ferrules 902 and receive ferrules 903 are flush with the bottom side of ferrule fixture 901. Alignment boxes are patterned on silicon die 908. The holes 907 at the bottom of transmit ferrules 902 are offset lower than the holes 910 at the bottom of receive ferrules 903 to account for the height difference between the top of VCSEL array 904 and the top of alignment box array 906 in which APD 905 and APD lens 909 are placed. The gap between transmit ferrules 902 and VCSEL 904 is kept as small as possible to maximize the VCSEL coupling. Similarly, the gap between receive ferrules 903 and APD 905 and APD lens 909 is kept as small as possible to maximize the APD signal.

In the embodiment of fiber optic cable coupling assembly 200 in FIGS. 2A, 2B, and 2C, transmit ferrules 902 and receive ferrules 903 are ferrules 212 (which are roughly perpendicular to the fibers) and VCSEL array 904 transmits optical signals into transmit ferrules 902 to optical devices 211 (shown in FIGS. 2A, 2B, and 2C) which in turn send the optical signals to fibers, and APD 905 and APD lens 909 receive light from receive ferrules 903 from optical devices 211 which received the optical signals from fibers.

In the embodiment of fiber optic cable coupling assembly 300 in FIG. 3, transmit ferrules 902 and receive ferrules 903 contain the fibers themselves and exchange optical signals with VCSEL array 904, APD 905, and APD lens 909 directly.

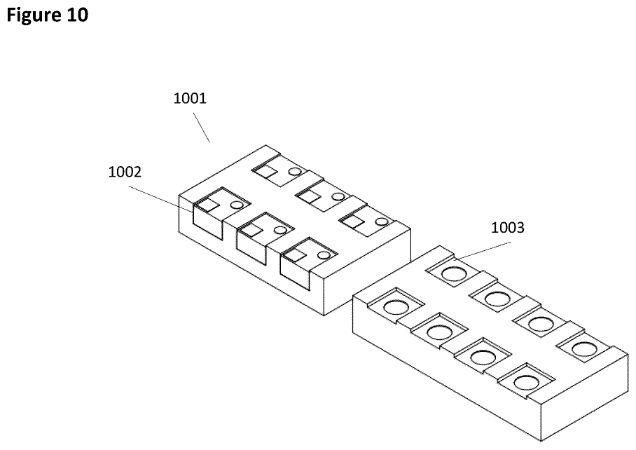

FIG. 10 shows another embodiment of alignment boxes 1001 that are lithographically defined. Horizontal sidewalls are omitted from the drawing for clarity. Alignment boxes 1001 include VCSEL alignment boxes 1002 etched into silicon surface with bulk micromachining techniques commonly used in MEMS (micro-electro-mechanical systems) fabrication. Additional height can be added to VCSEL alignment boxes 1002 with lithographically defined organic material. APD alignment boxes 1003 are also created with lithographically defined organic material.

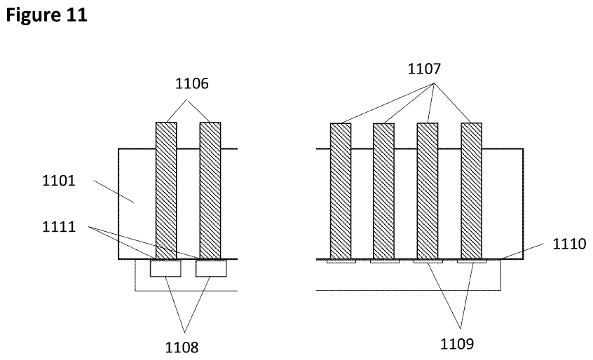

FIG. 11 depicts a cross-section of ferrule fixture 1101. The top of alignment boxes for VCSEL array 1108 and top of alignment boxes for APD array 1109 are on the same plane. The end 1111 of transmit ferrules 1106 and the end 1110 of receive ferrules 1107 are flush to the bottom side of ferrule fixture 1101. This makes the design of fiber ferrule fixture 1101 simpler because offset is not required on silicon die side of the fixture. Another advantage of this embodiment is that signal electrodes can connect to VCSEL array with lithographically defined metal, which is part of silicon wafer fabrication process, instead of wire bond. This facilitates design and manufacturing for high frequency operation.

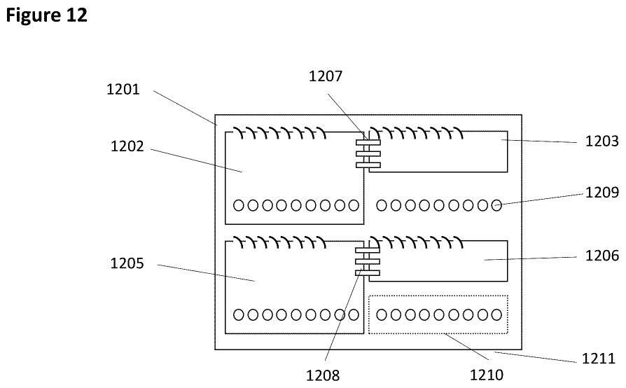

FIG. 12 shows a top view of an embodiment of coupling board 1201 with separate APD/TIA die 1202 and laser driver die 1203 directly mounted on coupling board 1201. The coupling fixture is omitted in the figure for clarity. Die 1202 and 1203 are connected to coupling board 1201 using wire bonds or TSVs or combination of both. Additional connections 1207 and 1208 can be made between dies 1202 and 1203 and between dies 1205 and 1206, respectively, using fan-out wafer-level packaging technology. VCSEL array and alignment boxes 1209 can be built directly on coupling board 1201. Alternatively, VCSEL array and alignment boxes 1211 can be built on a separate PCB 1210, which can be made of laminate or ceramic material. This is represented by the dotted line in the figure.

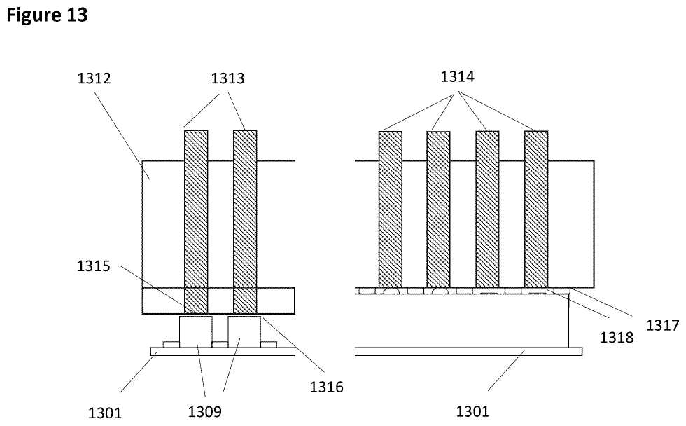

FIG. 13 depicts a cross-section of ferrule fixture 1312. Ferrule fixture 1312 is designed so that the end of transmit ferrules 1313 and the end of receive ferrules 1314 are flush to the bottom side of the fixture. If alignment boxes 1309 are built directly on coupling board 1301, holes 1315 for transmit ferrules 1313 are offset lower than holes 1317 for receive ferrules 1314 to account for the height difference between top of VCSEL array 1316 and top of APD alignment box array 1318. If alignment boxes are built on a separate PCB, the thickness of the separate PCB and APD/TIA die can be adjusted so the top of the alignment boxes are on the same plane, like the embodiment in FIG. 10. This makes the design of ferrule fixture 1312 simpler because offset is not required on VCSEL side of the fixture. By keeping PCB and silicon die the same height, fan-out wafer-level packaging technology can be used to connect signal electrodes to VCSEL array. This is done in the same lithographically defined process used to create connections 1207 and 1208 in FIG. 12.

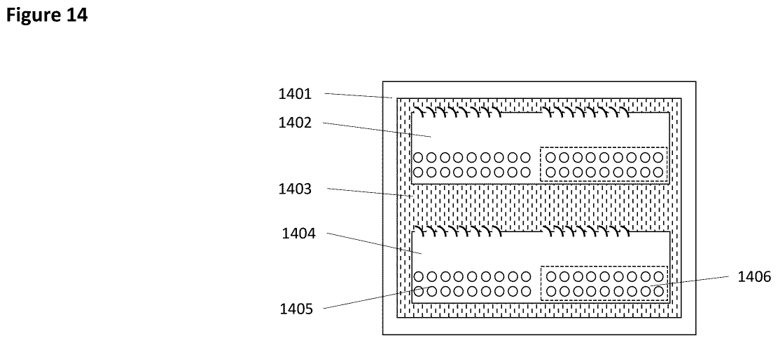

FIG. 14 shows another embodiment of a coupling board. Coupling board 1401 contains silicon dice 1402 and 1404 (upper-level silicon dice) assembled on another silicon die 1403 (lower-level silicon die). The coupling fixture is omitted in the figure for clarity. Lower-level and upper-level dice are assembled using 3D stacked silicon die packaging technology, which may include the use wire bonds or TSVs or combination of both. Any number of upper-level and lower-level dice may exist. Upper-level dice 1402 and 1404 includes APD array 1405 and VCSEL array 1406 with lithographically defined alignment boxes. Upper-level dice 1402 and 1404 also include TIA and laser driver (LD) circuitry. For example, lower-level die 1403 may contain the complete transceiver chip circuitry. The transceiver circuitry includes RX/TX analog circuits as well as DSP and re-timer circuit normally found on a separate chip on AOC PCB. This embodiment significantly reduces the size of AOC PCB and simplifies/reduces the high-speed signal path, thereby reducing overall power requirement.

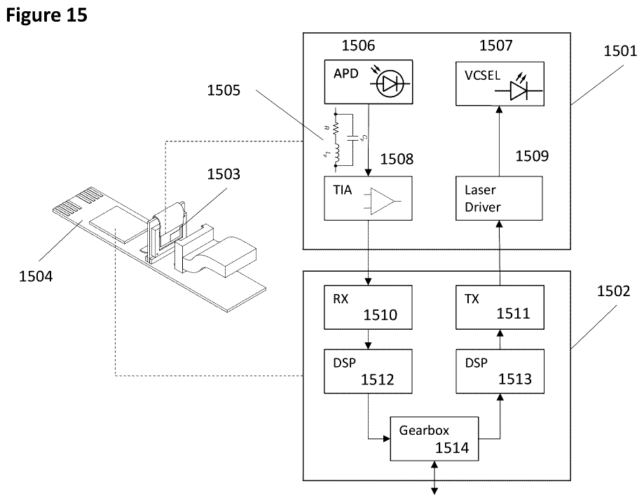

FIG. 15 illustrates the electrical aspects of the embodiments described herein. APDs 1506, VCSELs 1507, TIAs 1508, and laser drivers 1509 are integrated into a single die or package 1501, which is mounted on coupling board 1503. Transceiver functionalities such as receiver 1510, transmitter 1511, DSP 1512, DSP 1513, and gearbox 1514 are integrated on a separate die or package 1502 on the main AOC PCB 1504. For each APD 1506 and TIA 1508 pair, APD 1506's high frequency performance is critically dependent on parasitic resistance, inductance, and capacitance (RLC) 1505 between APD 1506 and TIA 1508. By moving APD 1506 and TIA 1508 in proximity on the same chip, these parasitic RLC 1505 are reduced significantly, by several orders of magnitude. Silicon APD has a very high intrinsic gain bandwidth product. By integrating APDs 1506 close to TIAs 1508 on the same silicon die, photodiode bandwidth reduction due to extrinsic RLC parasitic 1505 is minimized.

The integrated system described in this invention has several significant advantages. First, there is a large build-of-material (BOM) cost reduction of integrated system in various embodiments because multiple components, namely photodiodes, are eliminated. Second, there is a large manufacturing cost reduction because there is only a single, passive alignment step with precision machined coupling board and ferrule fixture. Third, there are yield advantages because each optical fiber in the array can be individually optimized through closed-loop control of AOC performance metrics. The third point is discussed further in the following figures.

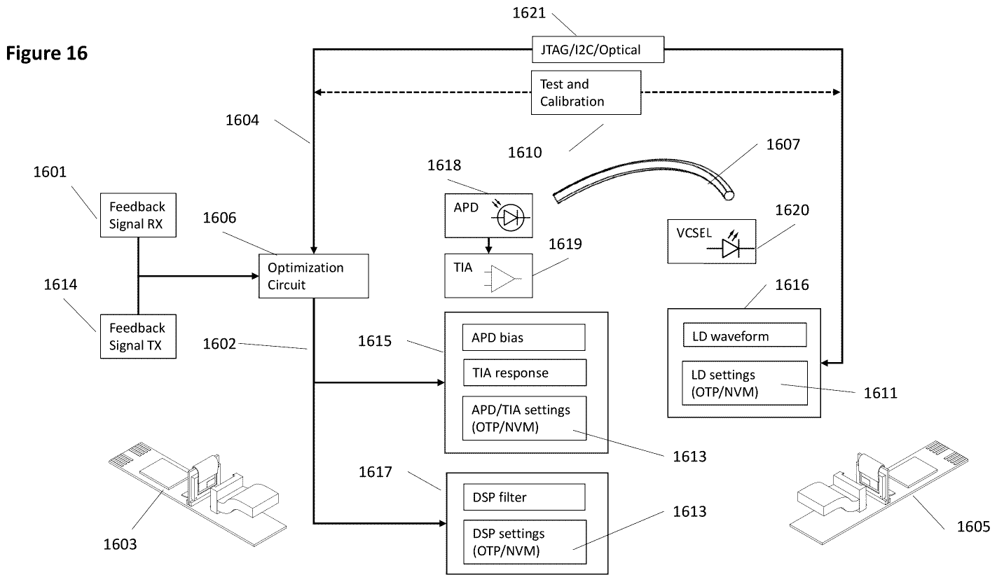

FIG. 16 shows how the integration approach of the embodiments herein allows closed-loop control and optimization of AOC performance metrics.

Optimization circuit 1606 generates and outputs the settings for APD bias, TIA response for receive side (RX) APD die 1615 and LD waveform for transmit side (TX) APD die 1616. These settings impact the characteristic performance of RX-side APD 1618, RX-side TIA 1619 and TX-side VCSEL 1620. Furthermore, optimization circuit 1606 outputs settings for DSP filters in DSP chip 1617. Feedback inputs to optimization circuit 1606 may be analog signal or digital signal from either RX PCB 1603 or TX PCB 1605.

Optimization circuit 1606 may exist in both RX PCB 1603 and TX PCB 1605, since AOC cables are usually bi-directional. Each circuit can work together with one assigned as primary and the other assigned as secondary. Alternately, each circuit can work independently or one of the circuits may be disabled. Feedback signals 1601 and 1614 for optimization may come from either RX PCB 1603 or TX PCB 1605 and may be either analog signal or digital signal.

There are two feedback control paths. Signaling for control path 1602 is contained within one AOC PCB. Signaling for control path 1604 requires communication between RX end and TX end of AOC cable bundle 1607. This is done by either test/calibration equipment 1610 or by signaling 1621 for control path through AOC cable bundle 1607. Signaling 1621 for control path can use any wired or ad-hoc optical protocol. Examples of wired signaling protocol include JTAG and I2C, but any custom signaling protocol may be used. This requires at least two wire lines to be routed between RX PCB 1603 and TX PCB 1605. For optical signaling, several optical fiber paths are assigned to transmit optimization inputs and settings for the other optical fiber paths in AOC cable bundle 1607. Alternately, low frequency signal can be sent through each optical fiber that includes optimization inputs and settings. An optical fiber can carry both high frequency and low frequency signal at the same time. Optimization circuit 1606 operates on APD/TIAs on RX-side of the cable and VCSEL/LDs on TX-side of the cable and TX/RX-side transceiver chips. The optimized settings are written into one-time programmable or non-volatile memory registers (OTP/NVM) 1611, 1612, and 1613.

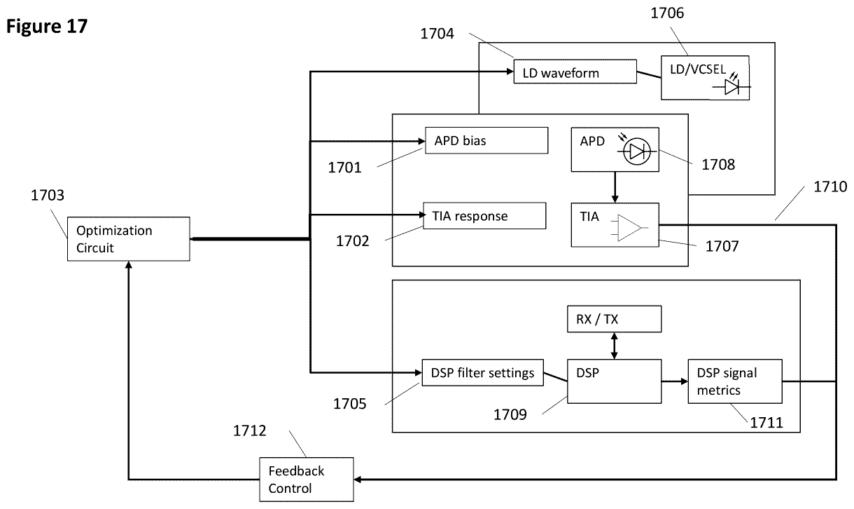

FIG. 17 further illustrates the type of controls that can be set by optimization circuit 1703. APD bias 1701 and TIA response 1702 improve the detection of received signal by APD 1708 and TIA 1707. Laser driver (LD) waveform 1704 impacts the quality of transmitted signal from VCSEL 1706. DSP filter settings 1705 optimize performance of DSP 1709. Inputs to optimization circuit 1703 are derived from APD/TIA signal 1710 and/or DSP metrics 1711 and passes through feedback control circuit 1712.

Optimization for AOC cable can be done for the entire system to maximize performance or to minimize power. Furthermore, each RX-to-TX path in the bundle can be optimized individually during manufacturing and throughout cable life. To give another example, for shorter cable lengths or lower data rate, simpler DSP algorithms can be used, or DSP omitted completely, which leads to application-specific power savings.

The use of optimization circuit 1703 during cable manufacturing through test/calibration equipment compensates for manufacturing variations in AOC components and alignment, which increases the AOC cable yield. Another method to increase AOC yield is to add redundant fiber optic cables to the fiber bundle. Because of component integration and single passive alignment used in this invention, there is only a small incremental cost to add redundant fibers.

By activating optimization circuit 1703 during field operation, the end user gains several major benefits. First, adjustments can be made to compensate for changes to AOC components, connected systems, or external environment. This improves the field reliability of the AOC cable deployment. Second, cable maintenance is simplified. Problems detected in the data link by connected equipment can be triaged remotely by isolating the underperforming fiber link and checking if cable is the root cause. This software-defined maintenance workflow reduces the maintenance cost of data centers.

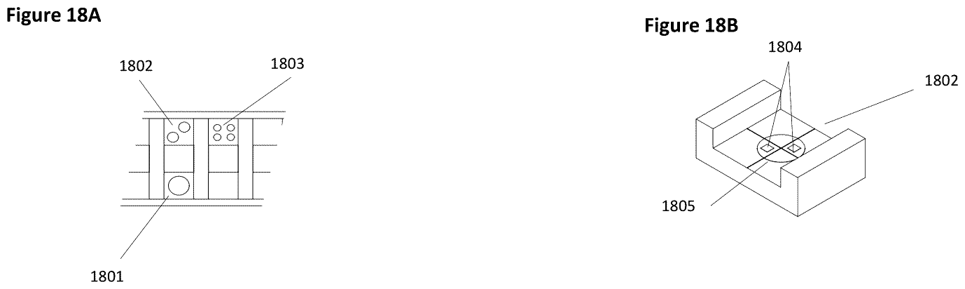

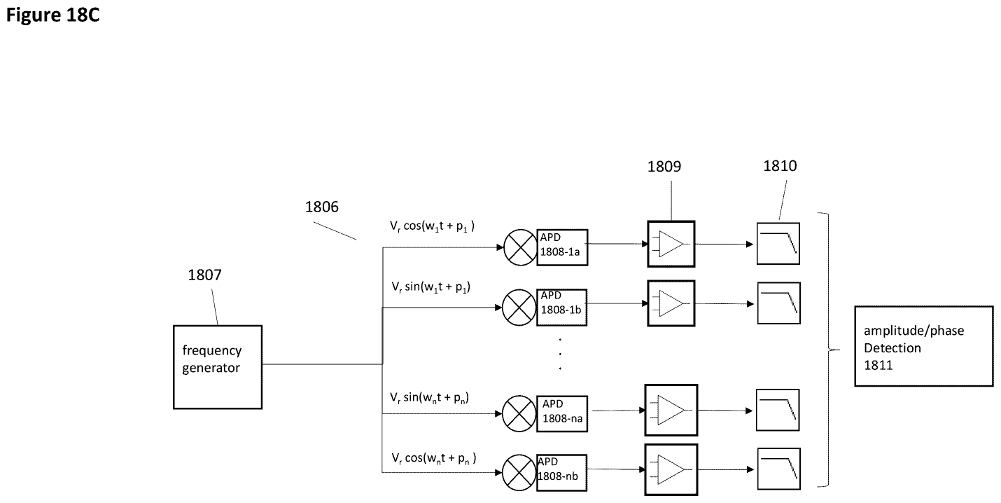

Optical fiber core in multi-mode fiber is 50 microns in diameter. Typically, one APD corresponds to each optical fiber. Because of the high sensitivity of integrated silicon APD, each APD will be much smaller than 50 microns. This is especially true for an APD that has been optimized for high frequency operation. This leads to the possibility of using a plurality of APDs for each fiber. FIG. 18A depicts alignment boxes 1801, 1802, and 1803, each of which receives one fiber. Alignment box 1801 contains one APD, alignment box 1802 contains two APDs, and alignment box 1803 contains four APDs. FIG. 18B shows alignment box 1802 containing two APDS 1804. A typical area of a multi-mode fiber core is shown by circle 1805. A single multi-mode fiber will couple with both APDs 1804.

APDs in a single alignment box can be biased independently to achieve different levels signal amplification. Most significantly for this invention, APDs can be used as a mixer. FIG. 18C depicts demodulation circuit 1806 using APDs. Frequency generator 1807 generates reference signals to modulate APDs operating in the linear portion of the APD amplification curve. In this example, n pairs of reference signals are generated. The first pair is Vᵣ cos (w₁t+p₁) and Vᵣ sin (w₁t+p₁), which are applied to APDs 1808-1a and 1808-1b, where APD 1808-1a is used for the in-phase component and APD 1808-1b is used for the 90-degree shifted quadrature component. Each APD is followed by TIA 1809 and low-pass filter (LPF) 1810, which allows for the two signals to be further processed in downstream circuits 1811 to detect both phase and amplitude. This design is followed for the remaining pairs of the n pairs of reference signals. For example, the nth pair is Vᵣ cos (wₙt+pₙ) and Vᵣ sin (wₙt+pₙ), which are applied to APDs 1808-na and 1808-nb This methodology allows demodulation of phase information in optical signals with less complex transceiver circuits and facilitates the use of higher-order quadrature amplitude modulation (QAM) schemes to increase data rates.

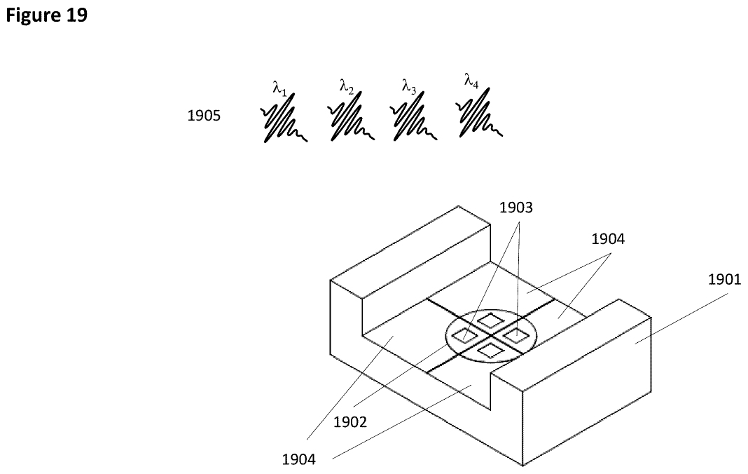

FIG. 19 shows another embodiment with multiple APDs per fiber. Alignment box 1901 has four APDs 1903 within the area of multi-mode fiber core, shown by circle 1902. A single multi-mode fiber will couple into all four APDs. Each quadrant 1904 of the alignment box is associated with a different bandpass optical filter to filter a narrow band of optical wavelength. The optical filters can be deposited and lithographically defined. This design enables high bandwidth multi-mode fiber to support wavelength-division multiplexing (WDM) with up to four signal wavelengths 1905 at AOC distances up to 50 m.

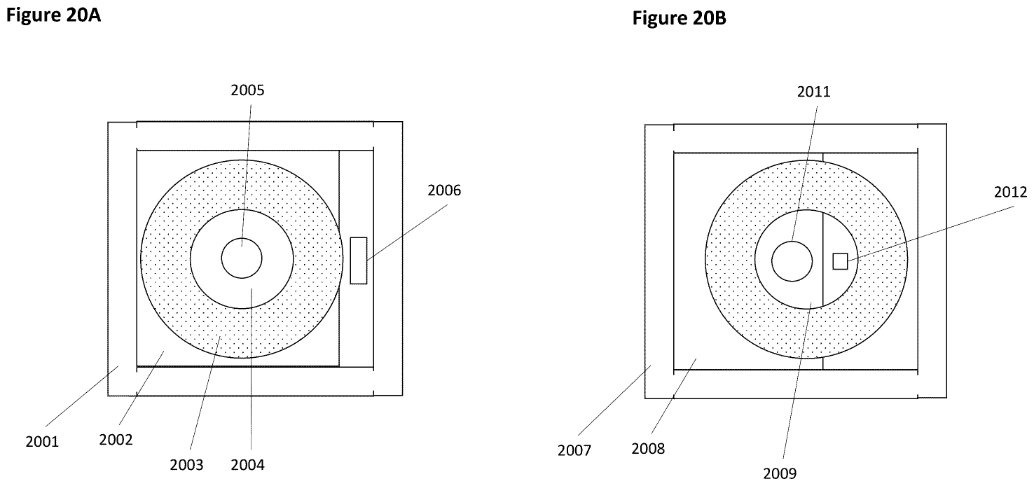

FIG. 20A shows an embodiment with VCSEL 2002 and APD 2006 in the same alignment box 2001. This embodiment uses APD 2006 to monitor the output level of VCSEL 2002, and the APD output signal can be another input to optimization circuit 1703 in FIG. 17. VCSEL die size and location of VCSEL's active light-emitting area 2005 can be customized. The active area 2005 of VCSEL is surrounded by the fiber core 2004 and fiber cladding 2003. APD 2006 is integrated on the die inside the alignment box 2001 and adjacent to VCSEL 2002. Even if APD 2006 is outside of the fiber cladding 2003, the reflected light from the fiber can be used by APD 2006 to monitor VCSEL 2002. Adding APD 2006 in this manner does not increase cost because APD 2006 can be added as part of silicon integration.

FIG. 20B shows another embodiment with VCSEL 2008 and APD 2012 in the same alignment box 2007. This embodiment has both VCSEL active area 2011 and APD 2012 within the fiber core 2009. The fiber can be used bi-directionally, as both a transmitter (through VCSEL 2008) and receiver (through APD 2012). This can be useful, for example, in communications according to communication standards that have an asymmetric mode that requires an unequal number of RX and TX paths to increase the transmission rate in one direction. This embodiment can be used as either a RX or TX path as needed.

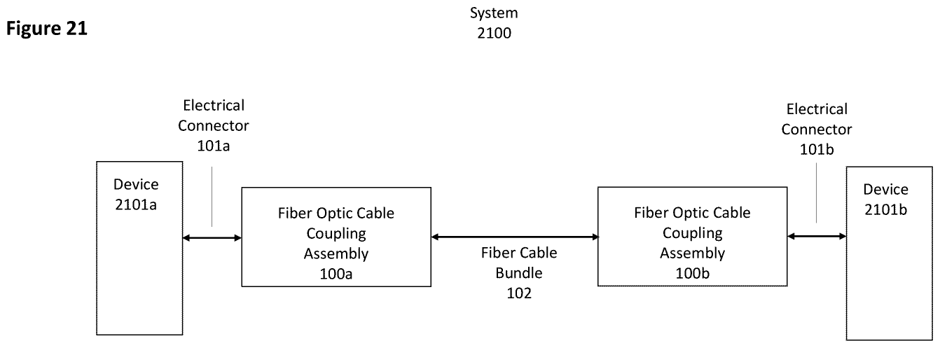

FIG. 21 depicts system 2100. System 2100 comprises devices 2101a and 2101b, electrical connectors 101a and 101b (which are instantiations of electrical connector 101 in FIG. 1), fiber optic cable coupling assemblies 100a and 100b (which are instantiations of fiber optic cable coupling assembly 100 in FIG. 1), and fiber optic cable bundle 102. Devices 2101a and 2101b can be servers, routers, switches, storage devices, or any other electrical device.

During operation, device 2101a transmits a signal to device 2101b by sending an electrical signal over electrical connector 101a. The electrical signal is translated into an optical signal by fiber optic cable coupling assembly 100a, and the optical signal is sent over fiber cable bundle 102. The optical signal is received by fiber optic cable coupling assembly 100b. The optical signal is translated into an electrical signal by fiber optic cable coupling assembly 100b, and the electrical signal is sent over electrical connector 101b to device 2101b. Device 2101a can transmit a signal to device 2101b using the same path in reverse.

It should be noted that, as used herein, the terms “over” and “on” both inclusively include “directly on” (no intermediate materials, elements or space disposed therebetween) and “indirectly on” (intermediate materials, elements or space disposed therebetween). Likewise, the term “adjacent” includes “directly adjacent” (no intermediate materials, elements or space disposed therebetween) and “indirectly adjacent” (intermediate materials, elements or space disposed there between), “mounted to” includes “directly mounted to” (no intermediate materials, elements or space disposed there between) and “indirectly mounted to” (intermediate materials, elements or spaced disposed there between), and “electrically coupled” includes “directly electrically coupled to” (no intermediate materials or elements there between that electrically connect the elements together) and “indirectly electrically coupled to” (intermediate materials or elements there between that electrically connect the elements together). For example, forming an element “over a substrate” can include forming the element directly on the substrate with no intermediate materials/elements therebetween, as well as forming the element indirectly on the substrate with one or more intermediate materials/elements there between.

What is claimed is:

1. A fiber optic cable coupling assembly comprising:
a coupling board containing a plurality of lasers and a plurality of photodiodes; and
a mechanical-optical interface comprising:
a first plurality of ferrules, where each laser in the plurality of lasers is aligned with a ferrule in the first plurality of ferrules; and
a second plurality of ferrules, wherein each photodiode in the plurality of photodiodes is aligned with a ferrule in the second plurality of ferrules.

2. The fiber optic cable coupling assembly of claim 1, wherein the lasers are vertical cavity surface emitting lasers.

3. The fiber optic cable coupling assembly of claim 1, wherein the photodiodes are integrated silicon photodiodes that can operate in avalanche mode.

4. The fiber optic cable coupling assembly of claim 1, wherein the first plurality of ferrules and the second plurality of ferrules contain fibers from a fiber optic cable bundle.

5. The fiber optic cable coupling assembly of claim 1, wherein the mechanical-optical interface further comprises:
a third plurality of ferrules connected to the first plurality of ferrules at approximately a 90 degree angle; and
a fourth plurality of ferrules connected to the second plurality of ferrules at approximately a 90 degree angle.

6. The fiber optic cable coupling assembly of claim 5, wherein the third plurality of ferrules and the fourth plurality of ferrules contain fibers from a fiber optic cable bundle.

7. The fiber optic cable coupling assembly of claim 6, further comprising in each of the third plurality of ferrules and the fourth plurality of ferrules a mirror or prism.

8. The fiber optic cable coupling assembly of claim 1, further comprising a transceiver coupled to the plurality of lasers and the plurality of photodiodes.

9. The fiber optic cable coupling assembly of claim 8, further comprising an electrical connector connected to the transceiver.

10. A coupling board assembly, comprising:
a coupling board;
a silicon die mounted on the coupling board;
a first plurality of alignment boxes on the silicon die, each box in the first plurality of alignment boxes containing a laser; and
a second plurality of alignment boxes on the silicon die, each box in the second plurality of alignment boxes containing one or more photodiodes.

11. The coupling board assembly of claim 10, wherein the first plurality of alignment boxes and the second plurality of alignment boxes are lithographically defined.

12. The coupling board assembly of claim 11, wherein the first plurality of alignment boxes and the second plurality of alignment boxes form an array of alignment boxes.

13. The coupling board assembly of claim 10, wherein the lasers are vertical cavity surface emitting lasers.

14. The coupling board assembly of claim 10, wherein the photodiodes are avalanche photodiodes.

15. The coupling board assembly of claim 10, wherein top surfaces of the lasers and top surfaces of the photodiodes are approximately in the same plane.

16. The coupling board assembly of claim 10, further comprising a second silicon die mounted on the coupling board.

17. The coupling board assembly of claim 10, wherein the silicon die comprises transimpedance amplifiers coupled to the photodiodes.

18. The coupling board assembly of claim 17, wherein the silicon die comprises laser drives coupled to the lasers.

19. The coupling board assembly of claim 10, wherein an alignment box in the second plurality of alignment boxes contains a plurality of photodiodes that form a mixer to demodulate a quadrature amplitude modulated signal.

20. The coupling board assembly of claim 10, wherein an alignment box in the second plurality of alignment boxes contains a plurality of photodiodes that are used to perform wavelength-division multiplexing.

21. A control system for a fiber optic cable coupling assembly, the control system comprising:
a photodiode bias control circuit;
a transimpedance amplifier; and
an optimization circuit to generate settings for the photodiode bias control circuit and the transimpedance amplifier.

22. The control system of claim 21 further comprising:
a digital signal processor;
wherein the optimization circuit generates settings for the digital signal processor.

23. The control system of claim 21, further comprising:
an alignment box containing a laser and a photodiode, wherein the photodiode provides a signal to the optimization circuit indicative of an output level of the laser.

24. A control system for a fiber optic cable coupling assembly, the control system comprising:
a laser driver; and
an optimization circuit to generate settings for the laser driver.

25. The control system of claim 24, further comprising:
a photodiode bias control circuit; and
a transimpedance amplifier;
wherein the optimization circuit generates settings for the photodiode bias control circuit and the transimpedance amplifier.

26. The control system of claim 24, further comprising:
an alignment box containing a laser and a photodiode, wherein the photodiode provides a signal to the optimization circuit indicative of an output level of the laser.

27. A coupling board assembly, comprising:
a coupling board;
a silicon die mounted on the coupling board; and
an alignment box on the silicon die, the alignment box containing a laser and a photodiode.

28. The coupling board assembly of claim 27, wherein the photodiode outputs a signal indicative of an output level of the laser.

29. The coupling board assembly of claim 27, wherein in a first mode the laser outputs light into a fiber and in a second mode the photodiode outputs a signal in response to light received from the fiber.
